(19) United States
(12) Patent Application Publication
(10) Pub. No.: US 2026/0098200 A1
(43) Pub. Date: Apr. 9, 2026

(54) ASPHALTENE AND PARAFFIN WAX DEPOSIT REMOVAL WITH SILICA NANOPARTICLES

(71) Applicant: ChampionX LLC, Sugar Land, TX (US)

(72) Inventors: Duy T. Nguyen, Richmond, TX (US); Christopher A. Russell, Sugar Land, TX (US)

(21) Appl. No.: 19/346,218

(22) Filed: Sep. 30, 2025

Related U.S. Application Data
(60) Provisional application No. 63/704,621, filed on Oct. 8, 2024.

(51) Int. Cl. C09K 8/524; E21B 37/06

(52) U.S. Cl. CPC C09K 8/524; E21B 37/06

(57) ABSTRACT

Compositions and methods for paraffin wax deposit removal and for asphaltene deposit removal from hydrocarbon production wellbores and equipment. The compositions contain a carrier component and a silica nanoparticle component, and the methods utilize the asphaltene or paraffin wax deposit removal compositions to remove paraffin wax deposits or asphaltene deposits from wellbores and/or equipment utilized in hydrocarbon production.

### CROSS REFERENCE TO RELATED APPLICATIONS

This application is a non-provisional patent application claiming the benefit of, and priority to, U.S. Provisional Patent Application No. 63/704,621, filed Oct. 8, 2024, which is incorporated by reference herein in its entirety.

### FIELD OF THE DISCLOSURE

The present disclosure generally relates to asphaltene and paraffin wax deposit removal for hydrocarbon production, and more particularly to the use of silica nanoparticles to enhance the removal of the asphaltene and paraffin wax deposits.

### BACKGROUND

Hydrocarbon fluids are generally produced from a subterranean formation to the surface, where the production fluids can be stored and/or transported.

Asphaltenes can be present in hydrocarbon fluids, especially crude oils. Special attention to asphaltene presence and deposit formation during the extraction and processing of these hydrocarbon fluids can be needed. Asphaltenes can deposit on surfaces, e.g., blocking reservoir pores in near-well formations, depositing a layer of particles on production equipment (e.g., tubing, pumps), and depositing a layer of particles on equipment downstream of the production equipment (e.g., desalters, pipelines, etc.). Chemical treatment of crude oil with additives, such as dispersants and inhibitors, is one of the most commonly adopted control options for the remediation and prevention of asphaltene deposition.

Paraffins can additionally or alternatively be present in hydrocarbon fluids. The production of hydrocarbon fluids in some locations can be subjected to temperatures in such a range that the paraffins may be present as solids. The paraffins can form a wax that agglomerates and deposits on surfaces in or through which the hydrocarbon fluid is produced, such as the wellbore, pipes, pumps, compressors, valves, storage vessels, and transportation vessels (rail cars, ocean tankers, etc.). The paraffin wax deposits reduce the effective volume of the structure in which they are deposited and can reduce the efficiency of producing hydrocarbon fluids and can lead to increased costs related to removing the paraffin wax deposits from the equipment.

There is ongoing effort for solutions to remediate both paraffin wax deposits and asphaltene deposits in hydrocarbon production.

### SUMMARY

Disclosed is an asphaltene or paraffin wax deposit removal composition that can include: a carrier component including an aromatic hydrocarbon, an aliphatic hydrocarbon, or both an aromatic hydrocarbon and an aliphatic hydrocarbon; and a silica nanoparticle component including silica nanoparticles and a continuous phase fluid, wherein the silica nanoparticles are present in a range of from 0.1 wt % to 1 wt % based on a total weight of the asphaltene or paraffin wax deposit removal composition.

Disclosed is an asphaltene deposit removal composition that can include: a carrier component including an aromatic hydrocarbon, and a silica nanoparticle component. The silica nanoparticle component includes silica nanoparticles and a continuous phase fluid, and the silica nanoparticles are present in a range of from 0.1 wt % to 1 wt % based on a total weight of the asphaltene deposit removal composition.

Disclosed is a paraffin wax deposit removal composition that can include: a carrier component including an aromatic hydrocarbon, an aliphatic hydrocarbon, or both an aromatic hydrocarbon and an aliphatic hydrocarbon; and a silica nanoparticle component. The silica nanoparticle component includes silica nanoparticles and a continuous phase fluid, and the silica nanoparticles are present in a range of from 0.1 wt % to 1 wt % based on a total weight of the asphaltene or paraffin wax deposit removal composition.

Also disclosed is a method that can include: introducing an asphaltene deposit or paraffin wax deposit removal composition into a wellbore or a production line that is fluidly coupled to the wellbore, where the wellbore or the production line contains an asphaltene deposit, a paraffin wax deposit, or both an asphaltene deposit and a paraffin wax deposit. The method can also include contacting the asphaltene deposit, the paraffin wax deposit, or both the asphaltene deposit and the paraffin wax deposit with the composition. Introducing and contacting can occur during or before producing a hydrocarbon-containing fluid from the wellbore.

Another method includes contacting an asphaltene deposit, a paraffin wax deposit, or both the asphaltene deposit and the paraffin wax deposit, in a wellbore or in a production line coupled with the wellbore, with the an asphaltene or paraffin wax deposit composition; and removing the asphaltene deposit, the paraffin wax deposit, or both the asphaltene deposit and the paraffin wax deposit based on the contacting.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a line graph of thermal fouling resistance (Rf) versus time for each of Examples 1 to 4.

FIG. 2 illustrates a bar graph of the time required for paraffin wax deposit removal for each of Examples 1 to 4.

FIG. 3 illustrates a line graph of thermal fouling resistance (Rf) versus time for each of Examples 5 to 8.

FIG. 4 illustrates a bar graph of the time required for asphaltene deposit removal for each of Examples 5 to 8.

FIG. 5 illustrates a graph of asphaltene concentration versus time for Examples 5, 7, and 8.

### DETAILED DESCRIPTION

As used herein, any recited ranges of values contemplate all values within the range including the end points of the range, and are to be construed as support for claims reciting any sub-ranges having endpoints which are real number values within the recited range. By way of example, a disclosure in this specification of a range of from 10 to 15 shall be considered to support claims to values of 10, 11, 12, 13, 14, and 15, and to any of the following ranges: 10-11, 10-12, 10-13, 10-14, 10-15, 11-12, 11-13, 11-14, 11-15, 12-13; 12-14, 12-15, 13-14, 13-15, and 14-15. Similarly, by way of another example, a disclosure in this specification of a range of from 1.0 to 1.5 shall be considered to support claims to values of 1.0, 1.1, 1.2, 1.3, 1.4, and 1.5, and to any of the following ranges: 1.0-1.1, 1.0-1.2, 1.0-1.3, 1.0-1.4, 1.0-1.5, 1.1-1.2, 1.1-1.3, 1.1-1.4, 1.1-1.5, 1.2-1.3; 1.2-1.4, 1.2-1.5, 1.3-1.4, 1.3-1.5, and 1.4-1.5.

Disclosed herein are asphaltene or paraffin wax deposit removal compositions and methods utilizing these compositions. The compositions contain silica nanoparticles, and it has been unexpectedly found that improvements in paraffin wax deposit and asphaltene wax deposit removal are inversely related to the concentration of silica nanoparticles in the compositions disclosed herein.

### Asphaltene or Paraffin Wax Deposit Removal Composition

The asphaltene or paraffin wax deposit removal composition can include a carrier component and a silica nanoparticle component.

### Carrier Component

The carrier component can include an aromatic hydrocarbon, an aliphatic hydrocarbon, or both an aromatic hydrocarbon and an aliphatic hydrocarbon. Embodiments of the carrier component can consist of one or more aromatic hydrocarbons, or can consist of one or more aliphatic hydrocarbons. Other embodiments can comprise the aromatic hydrocarbon, comprise the aliphatic hydrocarbon, or comprise both the aromatic and the aliphatic hydrocarbon.

In aspects, the aromatic hydrocarbon comprises xylene, toluene, or both xylene and toluene. In aspects, the aliphatic hydrocarbon comprises a C₄ to C₁₀ saturated hydrocarbon.

In aspects where the composition is an asphaltene deposit removal composition, the carrier component does not include an aliphatic hydrocarbon. In aspects where the composition is an asphaltene deposit removal composition, the carrier component can consist of one or more aromatic hydrocarbon.

In aspects where the composition is a paraffin wax deposit removal composition, the carrier component can include both the aromatic hydrocarbon and the aliphatic hydrocarbon. In other aspects where the composition is a paraffin wax deposit removal composition, the carrier component can consist of one or more aliphatic hydrocarbon.

In aspects, the aromatic hydrocarbon can be present in a range of from 1 wt % to 99 wt % based on a total weight of the asphaltene or paraffin wax deposit removal composition. In additional or alternative aspects, the aliphatic hydrocarbon can be present in a range of from 1 wt % to 99 wt % based on a total weight of the asphaltene or paraffin wax deposit removal composition. In some aspects, the aromatic hydrocarbon and the aliphatic hydrocarbon are present in a range of from 1 wt % to 99 wt % based on a total weight of the asphaltene or paraffin wax deposit removal composition.

### Silica Nanoparticle Component

The silica nanoparticle component can include silica nanoparticles and a continuous phase fluid.

### Silica Nanoparticles

Silica nanoparticles as disclosed herein are solid silica particles that have at least one dimension that is from 1 nm to 1,000 nm; from 1 nm to 900 nm; from 1 nm to 800 nm; from 1 nm to 700 nm; from 1 nm to 600 nm; from 1 nm to 500 nm; from 1 nm to 400 nm; alternatively, 1 nm to 300 nm; alternatively, 1 nm to 250 nm; alternatively, 1 nm to 100 nm; alternatively, 200 nm to 500 nm; alternatively, 200 nm to 400 nm; alternatively, 300 nm to 400 nm; alternatively, from 30 nm to 100 nm; alternatively, from 50 nm to 100 nm; alternatively, from 1 nm to 50 nm; alternatively, from 1 nm to 40 nm; alternatively, from 1 nm to 30 nm. The silica nanoparticles may assume a variety of geometries, such as spheres, hollow shells, rods, plates, ribbons, prisms, stars, or combinations thereof. All geometries of nanoparticles are understood to be within the scope of this disclosure. For example, a silica particle of 2 μm length and 10 nm diameter would be considered a “silica nanoparticle” even though one of its dimensions is larger than the largest dimension generally accepted for nanoparticles, i.e., 500 nm. In another example, a silica rod of 10 nm diameter and 5 μm length would be considered a nanoparticle (a rod-like nanoparticle, or nanorod).

In aspects, the at least one dimension is a diameter or approximate diameter of the silica nanoparticles. The size of the silica nanoparticles can be obtained by measuring the diameter or approximate diameter. For a population of nanoparticles, the diameter or approximate diameter can also be referred to as a Z-average particle size, which can be measured according to routine protocols known to one skilled in the art, for example, dynamic light scattering (DLS) (Z-average). Transmission Electron Microscopy (TEM) can also measure particle size.

In aspects, the silica nanoparticles are present in a range of from 10 wt % to 50 wt %; alternatively, from 20 wt % to 50 wt %; alternatively, from 25 wt % to 45 wt %; alternatively, from 30 wt % to 40 wt %; alternatively, 25, 26, 27, 28, 29, 30, 31, 32, 33, 34, 35, 36, 37, 38, 39, 40, 41, 42, 43, 44, or 45 wt % based on a total weight of the silica nanoparticle component.

In some aspects, the silica nanoparticles can be in the form of colloidal silica nanoparticles. Colloidal silica nanoparticles are produced and commercially available in dispersions (or sols for solid-liquid systems). Commercially available examples are discussed herein. In some aspects, the silica nanoparticles are present in a dispersion of colloidal silica particles in a continuous phase fluid. In these aspects, the dispersion can contain 1 wt % to 35 wt % colloidal silica and 65 wt % to 99 wt % continuous phase fluid based on a total weight of the silica nanoparticle component.

In aspects, a surface area of the silica nanoparticles can be in a range of 100 to 500 m²/g; alternatively, 150 to 450 m²/g; alternatively, 200 to 400 m²/g; alternatively 250 to 350 m²/g.

### Continuous Phase Fluid

In some embodiments, the continuous phase fluid can contain an aqueous fluid, a non-aqueous fluid, a surfactant, or a combination thereof.

### Aqueous Fluid

In aspects, the aqueous fluid of the continuous phase fluid can comprise or consist of water. Water can be embodied as fresh water, produced water, a brine, or a combination thereof. In aspects, the aqueous fluid can be present in a range of from 1 wt % to 20 wt % based on a total weight of the silica nanoparticle component.

### Non-Aqueous Fluid

In aspects, the non-aqueous fluid of the continuous phase fluid can include a glycol, an alcohol, an ether, an aromatic hydrocarbon, a ketone, an aliphatic hydrocarbon, or combinations thereof. In aspects, the non-aqueous fluid can be present in a range of from 50 wt % to 94 wt % based on a total weight of the silica nanoparticle component.

Examples of a glycol suitable for use in the continuous phase fluid of the silica nanoparticle component include ethylene glycol, diethylene glycol, 1,2-propylene glycol, 1,3-propylene glycol, or combinations thereof.

Examples of an alcohol suitable for use in the continuous phase fluid of the silica nanoparticle component include straight chain or branched aliphatic alcohols such as methanol, ethanol, propanol, isopropanol, butanol, 2-ethylhexanol, hexanol, octanol, decanol, 2-butoxyethanol, or combinations thereof.

Examples of an ether suitable for use in the continuous phase fluid of the silica nanoparticle component include ethylene glycol monobutyl ether (EGMBE), diethylene glycol monoethyl ether, or combinations thereof.

Examples of an aromatic hydrocarbon suitable for use in the continuous phase fluid of the silica nanoparticle component include toluene, xylene, heavy aromatic naphtha, fatty acid derivatives (acids, esters, amides), or combinations thereof.

Examples of a ketone suitable for use in the continuous phase fluid of the silica nanoparticle component include methyl ethyl ketone, cyclohexanone, diisobutylketone, or combinations thereof.

Examples of aliphatic hydrocarbons suitable for use in the continuous phase fluid of the silica nanoparticle component include one or more C₄ to C₁₀ saturated hydrocarbons.

### Surfactant

In aspects, the surfactant in the continuous phase fluid can include surfactants having a hydrophilic-lipophilic balance (HLB) in a range of from 6 to 10. An example of a surfactant suitable for use in the continuous phase fluid of the silica nanoparticle component is an alkylbenzene sulfonic acid such as dodecylbenzene sulfonic acid. In aspects, the surfactant can be present in a range of from 5 wt % to 30 wt % based on a total weight of the silica nanoparticle component. In aspects, the surfactant can be present in a range of from 0.1 wt % to 1 wt % based on a total weight of the asphaltene deposit or paraffin wax deposit removal composition.

### Continuous Phase Features

In aspects where the continuous phase fluid includes a non-aqueous fluid and does not include an aqueous fluid, the silica nanoparticle component can be embodied as a dispersion of the silica nanoparticles in the continuous phase fluid.

In aspects where the continuous phase fluid includes an aqueous fluid and a non-aqueous fluid, the silica nanoparticle component can be embodied as an emulsion containing the silica nanoparticles. In aspects, the emulsion can be a water-in-hydrocarbon microemulsion where the hydrocarbon is the continuous phase and water is the dispersed phase, and the silica nanoparticles are dispersed in the continuous phase of the hydrocarbon.

In aspects, after combining the silica nanoparticle component with the carrier component and the continuous phase fluid is a non-aqueous fluid, the composition is a dispersion of the silica nanoparticles in a mixture of the continuous phase fluid and the carrier component.

In aspects, after combining the silica nanoparticle component with the carrier component and the continuous phase fluid is an aqueous fluid and a non-aqueous fluid, the composition is a dispersion of the silica nanoparticles in the non-aqueous fluid.

Silica nanoparticles in an aqueous fluid (sols) are available commercially. For example, aqueous or aqueous alcohol dispersions of silica nanoparticles are commercially available under the tradenames LUDOX® from W.R. Grace & Co.-Conn., NYACOL® or NEXSIL® from NYACOL® Nano Technologies, Inc., or other sols from ECOLAB®. One useful silica sol with an average particle size of 7-9 nm, a nominal solids content of 30.11 wt %, and a surface area of 330 m²/g is available as NALCO 1130 from ECOLAB®. These commercially available silica sols can be used as the silica nanoparticle component or as part of the silica nanoparticle component, with other species of the carrier phase fluid described herein used in combination with the aqueous fluid in these commercially available products to form the silica nanoparticle component.

Silica nanoparticles in non-aqueous fluid (sols) are available commercially. For example, non-aqueous dispersions of silica nanoparticles are commercially available under the tradename ORGANOSILICASOL™ from Nissan Chemical America Corporation. These commercially available silica sols can be used as the silica nanoparticle component or as part of the silica nanoparticle component, with other species of the carrier phase fluid described herein used in combination with the non-aqueous fluid in these commercially available products to form the silica nanoparticle component.

In aspects, the continuous phase fluid is present in a range of from 10 wt % to 90 wt %; alternatively, from 20 wt % to 80 wt %; alternatively, from 30 wt % to 80 wt %; alternatively, from 40 wt % to 80 wt %; alternatively, from 50 wt % to 80 wt %; alternatively, from 60 wt % to 80 wt %; alternatively, from 60 wt % to 70 wt % based on a total weight of the silica nanoparticle component.

In aspects, the silica nanoparticles are present in an amount that is equal to greater than 0.01, 0.02, 0.03, 0.04, 0.05, 0.06, 0.07, 0.08, 0.09, or 0.1 wt % based on a total weight of the asphaltene or paraffin wax deposit removal composition. In aspects, the silica nanoparticles are present in an amount that is equal to a less than 1.0, 0.9, 0.8, 0.7, 0.6, 0.5 wt % based on a total weight of the asphaltene or paraffin wax deposit removal composition. In aspects, the silica nanoparticles are present in an amount that is equal or greater than any minimum amount disclosed herein and equal or less than any maximum amount disclosed herein based on a total weight of the asphaltene or paraffin wax deposit removal composition. In aspects, the silica nanoparticles are present in a range of from 0.01 wt % to 1 wt %; alternatively, from 0.01 wt % to 0.9 wt %; alternatively, from 0.1 wt % to 0.8 wt %; alternatively, from 0.01 wt % to 0.7 wt %; alternatively, from 0.01 wt % to 0.6 wt %; alternatively, from 0.01 wt % to 0.5 wt %; alternatively, from 0.01 wt % to 0.4 wt %; alternatively, from 0.01 wt % to 0.3 wt %; alternatively, from 0.01 wt % to 0.25 wt %; alternatively, from 0.01 wt % to 0.2 wt %; alternatively, from 0.01 wt % to 0.15 wt % based on a total weight of the asphaltene or paraffin wax deposit removal composition.

### Specific Compositions

In aspects of the asphaltene or paraffin wax deposit removal composition, a dispersion of the silica nanoparticles in a non-aqueous fluid is present in a range of from 1 wt % to 20 wt %, and the same or another non-aqueous fluid is present in a range of from 80 wt % to 99 wt %.

In aspects of the asphaltene or paraffin wax deposit removal composition, a dispersion of the silica nanoparticles in a non-aqueous fluid is present in a range of from 1 wt % to 20 wt %, the same or another non-aqueous fluid is present in a range of from 50 wt % to 94 wt %, and a surfactant is present in a range of from 5 wt % to 30 wt % based on a total weight of the silica nanoparticle component.

In aspects of the asphaltene or paraffin wax deposit removal composition, a dispersion or emulsion of the silica nanoparticles in an aqueous fluid is present in a range of from 1 wt % to 20 wt %, a non-aqueous fluid is present in a range of from 50 wt % to 94 wt %, and a surfactant is present in a range of from 5 wt % to 30 wt % based on a total weight of the silica nanoparticle component.

### Asphaltene Deposit Removal Composition

The asphaltene deposit removal composition can include a carrier component comprising or consisting of one or more aromatic hydrocarbon, and a silica nanoparticle component comprising a continuous phase fluid and silica nanoparticles disclosed herein. In aspects, the carrier component of the asphaltene deposit removal composition does not include an aliphatic hydrocarbon and only one or more aromatic hydrocarbon(s) is/are included in the carrier component. When the silica nanoparticle component of the asphaltene deposit removal composition is embodied as a dispersion, the continuous phase fluid can include one or a combination of the non-aqueous fluids disclosed herein and does not include an aqueous fluid. When the silica nanoparticle component of the asphaltene deposit removal composition is embodied as an emulsion, the continuous phase fluid can include one or a combination of the non-aqueous fluids disclosed herein and one or more of the aqueous fluid(s) disclosed herein, and in some cases, one or more of the surfactant(s) disclosed herein.

### Paraffin Wax Deposit Removal Composition

The paraffin wax deposit removal composition can include a carrier component and a silica nanoparticle component. In aspects, the carrier component of the paraffin wax deposit removal composition includes or consists of one or more aliphatic hydrocarbon(s). In some aspects, the carrier component of the paraffin wax deposit removal composition can further include one or more aromatic hydrocarbon(s). When the silica nanoparticle component of the paraffin wax deposit removal composition is embodied as a dispersion, the continuous phase fluid can include one or a combination of the non-aqueous fluids disclosed herein and does not include an aqueous fluid. When the silica nanoparticle component of the paraffin wax deposit removal composition is embodied as an emulsion, the continuous phase fluid can include one or a combination of the non-aqueous fluids disclosed herein and one or more of the aqueous fluid(s) disclosed herein, and in some cases, one or more of the surfactant(s) disclosed herein.

### Methods

A method can include introducing an asphaltene or paraffin wax deposit composition described herein into a wellbore or a production line that is fluidly coupled to the wellbore. The wellbore or the production line contains an asphaltene deposit, a paraffin wax deposit, or both an asphaltene deposit and a paraffin wax deposit.

In aspects, the method can additionally include producing a hydrocarbon-containing fluid from a subterranean formation via the wellbore. In aspects, introducing the composition adds the composition to the hydrocarbon-containing fluid while producing the hydrocarbon-containing fluid or before producing the hydrocarbon-containing fluid. The hydrocarbon-containing fluid can include a crude oil, a natural gas liquid, a natural gas, a produced water, or combinations thereof.

In aspects, the method can include contacting the asphaltene deposit, the paraffin wax deposit, or both the asphaltene deposit and the paraffin wax deposit with the an asphaltene or paraffin wax deposit composition. In some aspects, contacting occurs during the producing, while in other aspects, contacting occurs before producing. In some aspects, the paraffin wax deposit is in the wellbore or in the production line. In some aspects, the asphaltene deposit is in the wellbore of in the production line.

In aspects, the method can include removing the asphaltene deposit, the paraffin wax deposit, or both the asphaltene deposit and the paraffin wax deposit based on the contacting. Removing can occur before, during, or both before and during producing.

Another method includes contacting an asphaltene deposit, a paraffin wax deposit, or both the asphaltene deposit and the paraffin wax deposit, in a wellbore or in a production line coupled with the wellbore, with the an asphaltene or paraffin wax deposit composition; and removing the asphaltene deposit, the paraffin wax deposit, or both the asphaltene deposit and the paraffin wax deposit based on the contacting.

Another method disclosed herein can include preparing an asphaltene or paraffin wax deposit composition described herein. Preparing can include combining the silica nanoparticle component and the carrier component to from the asphaltene or paraffin wax deposit composition. Prior to combining the silica nanoparticle component and the carrier component, the method can include preparing the carrier component and preparing the silica nanoparticle component.

The carrier component can be prepared by obtaining an aromatic hydrocarbon, obtaining an aliphatic hydrocarbon, or obtaining both the aromatic hydrocarbon and the aliphatic hydrocarbon. In cases where both hydrocarbons are obtained, the method can include mixing the aromatic hydrocarbon and the aliphatic hydrocarbon to form the carrier component.

The silica nanoparticle component can be formed by combining silica nanoparticles with a continuous phase fluid. Additionally, a surfactant can be combined with the continuous phase fluid before or after nanoparticle addition to form the silica nanoparticle component. Alternatively, the silica nanoparticle component can be formed by obtaining a commercially available silica nanoparticle sol. Alternatively, the silica nanoparticle component can be formed by combining a commercially available silica nanoparticle sol with a continuous phase fluid described herein to form the silica nanoparticle component. Alternatively, the silica nanoparticle component can be formed by combining a commercially available silica nanoparticle sol, a continuous phase fluid described herein, and a surfactant described herein to form the silica nanoparticle component.

### EXAMPLES

The following examples are intended to illustrate various aspects and embodiments of the disclosed compositions for paraffin wax deposit removal and compositions for asphaltene deposit removal, and are not to be considered limiting. It will be recognized that various modifications and changes may be made to the experimental compositions described herein, and without departing from the scope of the claims.

### Removal of Paraffin Wax Deposits

Examples 1 to 4 demonstrate compositions for removal of paraffin wax deposits. Examples 1 utilized a solvent and contained no silica nanoparticles as a comparative example, and Examples 2 to 4 included the solvent of Example 1 as the carrier component in combination with a non-aqueous dispersion of silica nanoparticles at various concentrations. The dispersion of the silica nanoparticles contained about 30 wt % silica nanoparticles and about 70 wt % methyl ethyl ketone as the continuous phase fluid. The silica nanoparticles in the dispersion had a particles size in a range of 10 to 15 nanometers (nm). The dispersion is commercially available as ORGANOSILICASOL™ MEK-ST from Nissan Chemical America Corporation.

Example 1 was a comparative example containing only the solvent which is the carrier component for Examples 2 to 4. The solvent was a blend of toluene and hexane, containing 60 wt % toluene and 40 wt % hexane based on a total weight of the solvent. No silica nanoparticles were present in Example 1.

Example 2 contained 300 g of the solvent of Example 1 as a carrier component and 2.65 g of the non-aqueous dispersion of silica nanoparticles, such that the paraffin wax deposit removal composition contained 0.26 wt % silica nanoparticles based on a total weight of the composition.

Example 3 contained 300 g of the solvent of Example 1 as a carrier component and 5.21 g of the non-aqueous dispersion of silica nanoparticles, such that the paraffin wax deposit removal composition contained 0.51 wt % silica nanoparticles based on a total weight of the composition.

Example 4 contained 300 g of the solvent of Example 1 as a carrier component, 2 g of dodecyl benzene sulfonic acid (DDBSA) as a surfactant, and 11.04 g of the non-aqueous dispersion of silica nanoparticles, such that the paraffin wax deposit removal composition contained 1.0 wt % silica nanoparticles and 0.6 wt % DDBSA based on a total weight of the composition.

Each of Examples 1 to 4 was subjected to a paraffin wax deposition removal experiment. Each experiment calculated a thermal fouling resistance (Rf) over time for the composition in a test hydrocarbon fluid by measuring a temperature of the test apparatus. The thermal fouling resistance can be calculated according to the following equation:

$$Rf = \frac{1}{U} - \frac{1}{Uc}$$

where U is the heat transfer coefficient of the fouled surface and Uc is the heat transfer coefficient of the clean surface. The test hydrocarbon fluid was xylene at a volume of 380 ml. A paraffin wax deposit obtained from field equipment was melted to a liquid phase, and the melted wax was then poured into a mold of the test section of the sensor assembly and allowed to cool and solidify. The wax mold was then placed into the test section for the sensor assembly. The sensor assembly included a resistance temperature detector (RTD) having a surface that can be individually heated and temperature monitored. The test hydrocarbon fluid was pre-heated and cooled to a starting temperature. The sensor assembly was added into the test fluid. The sensor assembly was electrically connected to a computer containing software for logging temperature and to a power supply modulator. The logging temperature software and power supply modulator were started. The composition of the respective example was then added to the test fluid. The experiment was conducted until the temperature reached a constant lower temperature than the starting temperature, indicating no more removal of the paraffin wax deposit from the sensor assembly. During experiment, the power supply modulator provided 50 V electrical signals to the sensor for 10 seconds, every 60 seconds. The temperature measured by the sensor was monitored versus time to provide information about the paraffin wax deposit, which acted as a thermal insulator. Higher temperatures indicated the presence of more paraffin wax deposit and lower temperatures indicated the presence of less paraffin wax deposit.

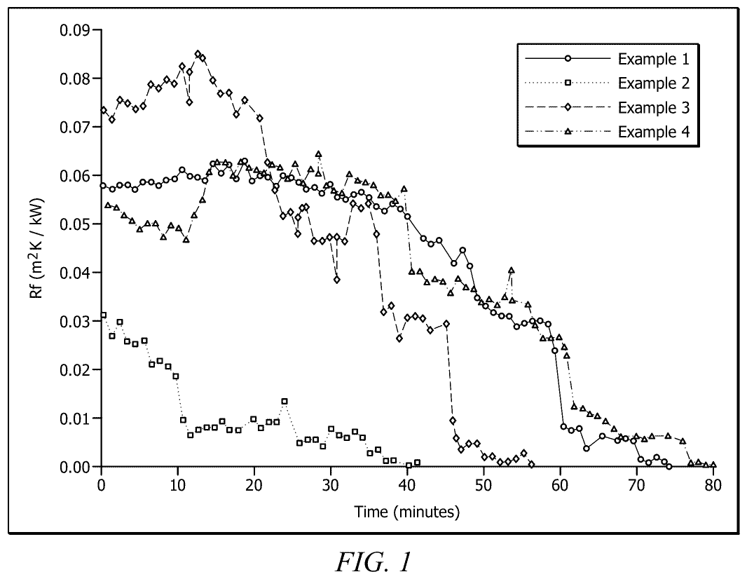

FIG. 1 illustrates a line graph of thermal fouling resistance (Rf) that was calculated for each temperature measurement versus time, for each of Examples 1 to 4. Units for thermal fouling resistance were m²K/kW and units for time were minutes.

The time to an Rf value to a plateau was compared amongst the examples. Example 1 was the comparative example of only the carrier component in the test fluid, containing no silica nanoparticles. It can be seen that about 1 wt % of silica nanoparticles in Example 4 ultimately did not remove the paraffin wax faster than the composition in Example 1 containing no silica nanoparticles, which was unexpected. Even more unexpected was that Examples 2 and 3 demonstrate that concentrations lower than 1 wt % of silica nanoparticles in the composition decreased the paraffin wax deposit removal time compared to Example 1 and Example 4.

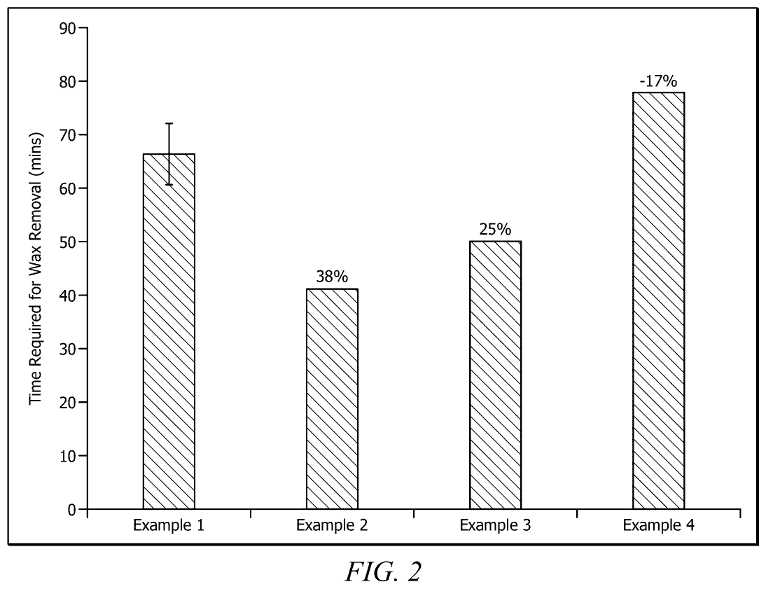

FIG. 2 illustrates a bar graph of the time required for paraffin wax deposit removal for each of Examples 1 to 4. The times indicated in FIG. 2 were determined by analyzing the time the thermal fouling resistance took to reach a Rf value plateau in the data of FIG. 1 for each of Examples 1 to 4. The Rf value plateau indicated that paraffin wax deposit removal was complete and was generally a lower value than the starting Rf value for each Example 1 to 4.

Example 2 had about 38% lower time for paraffin wax deposit removal compared to the time for paraffin wax deposit removal for Example 1. Example 3 had about 25% lower time for paraffin wax deposit removal compared to the time for paraffin wax deposit removal for Example 1. Example 4 actually took about 17% longer (indicated by a −17% value) for paraffin wax deposit removal when 1 wt % silica nanoparticles were used along with 0.6 wt % DDBSA. The 38% and 25% reduction in paraffin wax deposit removal time of Examples 2 and 3 compared to Example 1 was unexpected not only because Examples 2 and 3 contained concentrations of silica nanoparticles less than 1 wt %, but because of the magnitude of the reduction in removal time compared to Example 1, which was significant.

### Removal of Asphaltene Deposits

Examples 5 to 8 demonstrate compositions for removal of asphaltene deposits. Examples 5 utilized a solvent and contained no silica nanoparticles as a comparative example, and Examples 6 to 8 included the solvent of Example 5 as a carrier component in combination with a non-aqueous dispersion of silica nanoparticles at various concentrations. The non-aqueous dispersion of the silica nanoparticles contained about 40 wt % silica nanoparticles and about 60 wt % toluene as the continuous phase fluid. The silica nanoparticles in the non-aqueous dispersion had a particles size in a range of 10 to 15 nanometers (nm). The dispersion is commercially available as ORGANOSILICASOL™ TOL-ST from Nissan Chemical America Corporation.

Example 5 was a comparative example containing only solvent which is the carrier component for Examples 6 to 8. The solvent was xylene. No silica nanoparticles were present in Example 5.

Example 6 contained 300 g of the solvent of Example 1 as a carrier component and 1.10 g of the non-aqueous dispersion of silica nanoparticles, such that the asphaltene deposit removal composition contained 0.15 wt % silica nanoparticles based on a total weight of the composition.

Example 7 contained 300 g of the solvent of Example 1 as a carrier component and 1.90 g of the non-aqueous dispersion of silica nanoparticles, such that the asphaltene deposit removal composition contained 0.25 wt % silica nanoparticles based on a total weight of the composition.

Example 8 contained 300 g of the solvent of Example 1 as a carrier component and 3.80 g of the non-aqueous dispersion of silica nanoparticles, such that the asphaltene deposit removal composition contained 0.50 wt % silica nanoparticles based on a total weight of the composition.

Each of Examples 5 to 8 was subjected to an asphaltene deposition removal experiment. Each experiment calculated a thermal fouling resistance (Rf) over time for the composition in a test hydrocarbon fluid by measuring a temperature of the test apparatus. The test hydrocarbon fluid was xylene at a volume of 380 ml. An asphaltene deposit obtained from field equipment was placed in the test section of the sensor assembly of the test apparatus. The test hydrocarbon fluid was pre-heated and cooled to a starting temperature. The sensor assembly was added into the test fluid. The sensor assembly was electrically connected to a computer containing software for logging temperature and to a power supply modulator. The logging temperature software and power supply modulator were started. The composition of the respective example was then added to the test fluid. The experiment was conducted until the temperature reached a constant lower temperature than the starting temperature, indicating no more removal of the asphaltene deposit from the sensor assembly. During experiment, the power supply modulator provided 50 V electrical signals to the sensor for 10 seconds, every 60 seconds. The temperature measured by the sensor was monitored versus time to provide information about the asphaltene deposit, which acted as a thermal insulator. Higher temperatures indicated the presence of more asphaltene deposit and lower temperatures indicated the presence of less asphaltene deposit.

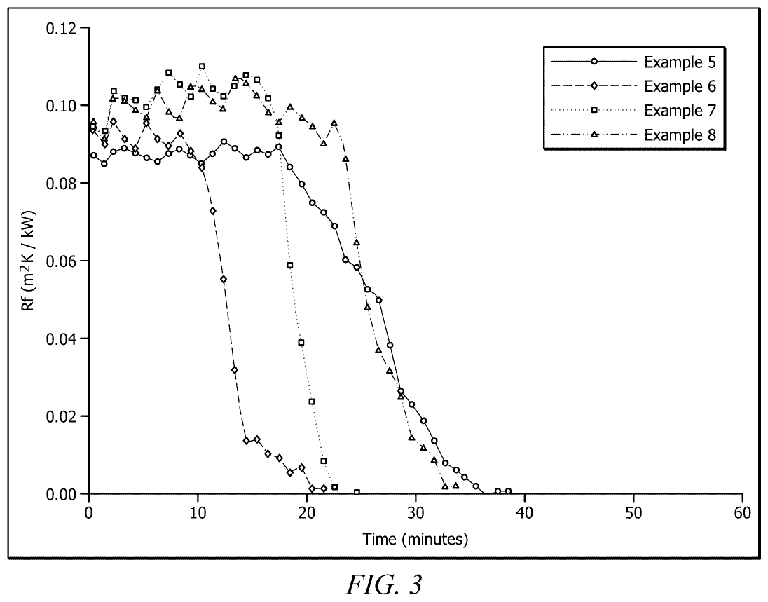

FIG. 3 illustrates a line graph of thermal fouling resistance (Rf) that was calculated for each temperature measurement versus time, for each of Examples 5 to 8. Units for thermal fouling resistance were m²K/kW and units for time were minutes.

The time to an Rf value to a plateau was compared amongst the examples. Example 5 was the comparative example of only the carrier component in the test fluid, containing no silica nanoparticles. It can be seen that all the Examples 6 to 8 containing silica nanoparticles had a lower time to plateau than Example 5 that contained no silica nanoparticles. It was unexpected to find that Examples 6 to 8 demonstrate that reducing concentrations of silica nanoparticles in the composition decreased the asphaltene deposit removal time.

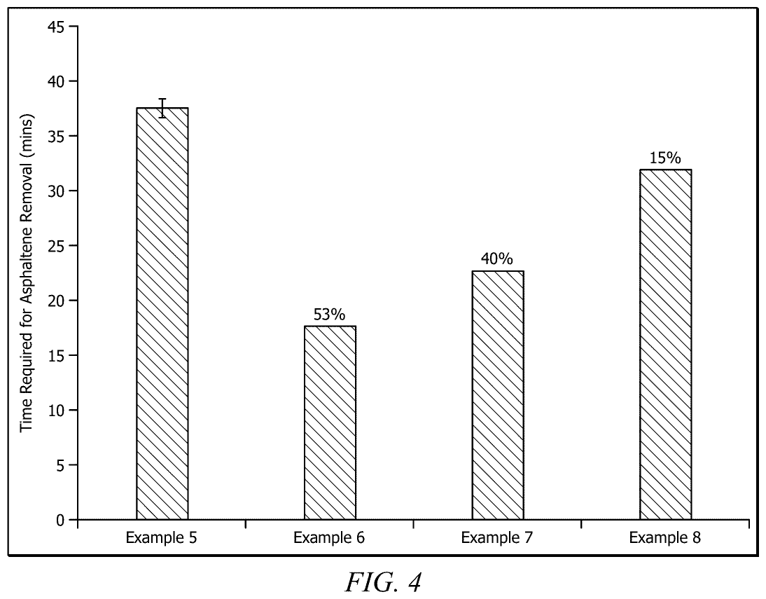

FIG. 4 illustrates a bar graph of the time required for asphaltene deposit removal for each of Examples 5 to 8. The times indicated in FIG. 4 were determined by analyzing the time the thermal fouling resistance took to reach a Rf value plateau in the data of FIG. 3 for each of Examples 5 to 8. The Rf value plateau indicated that removal of the asphaltene deposit was complete and was generally a lower value than the starting Rf value for each Example 5 to 8.

Example 6 had about 53% lower time for asphaltene deposit removal compared to the time for asphaltene deposit removal for Example 5. Example 7 had about 40% lower time for asphaltene deposit removal compared to the time for asphaltene deposit removal for Example 5. Example 8 had about 15% lower time for asphaltene deposit removal compared to the time for asphaltene deposit removal for Example 5. The 53%, 40%, and 15% reduction in asphaltene deposit removal time of Examples 6 to 8 compared to Example 5 was unexpected not only because removal time decreased with decreasing amounts of silica nanoparticles, but because of the magnitude of the reduction in removal time compared to Example 5, which was significant.

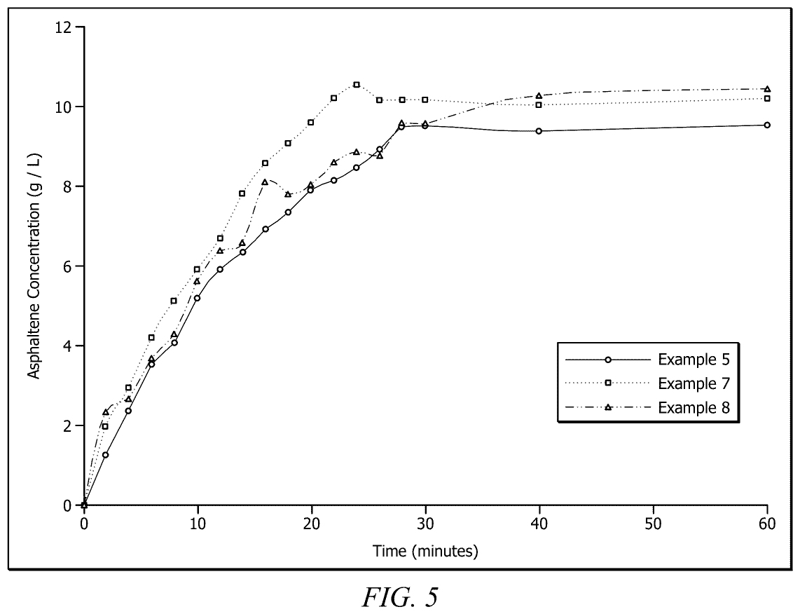

FIG. 5 illustrates a graph of asphaltene concentration versus time for Examples 5, 7, and 8. The concentration of asphaltene was obtained by removing aliquots of the test fluid during experiment of Examples 5, 7, and 8. The asphaltene content was obtained using a pre-calibrated Electron Spin Resonance apparatus (μESR apparatus). 500 μl of the removed test fluid at a given time was placed in a test cell. The test cell was then placed in the μESR apparatus, and a response was measured. The response peak height was compared to a calibration curve to calculate asphaltene concentration that is illustrated in FIG. 5. The data in FIG. 5 indicates a clear correlation to the thermal fouling resistance Rf data in FIG. 3. The composition of Example 7 achieved the greatest concentration of asphaltene material in the test fluid in less time than the comparative composition in Example 5 that had no silica nanoparticles and the composition in Example 8 that had a higher concentration of silica nanoparticles than Example 7.

### Additional Description

Aspect 1. An asphaltene or paraffin wax deposit removal composition comprising: a carrier component comprising an aromatic hydrocarbon, an aliphatic hydrocarbon, or both an aromatic hydrocarbon and an aliphatic hydrocarbon; and a silica nanoparticle component comprising silica nanoparticles and a continuous phase fluid, wherein the silica nanoparticles are present in a range of from 0.1 wt % to 1 wt % based on a total weight of the asphaltene or paraffin wax deposit removal composition.

Aspect 2. The asphaltene or paraffin wax deposit removal composition of Aspect 1, wherein the silica nanoparticles have an average particle size of from 1 nm to 1,000 nm.

Aspect 3. The asphaltene or paraffin wax deposit removal composition of Aspect 1 or 2, wherein the silica nanoparticles are present in a range of from 30 wt % to 40 wt % and the continuous phase fluid is present in a range of from 60 wt % to 70 wt % based on a total weight of the silica nanoparticle component.

Aspect 4. The asphaltene or paraffin wax deposit removal composition of any one of Aspects 1 to 3, wherein the aromatic hydrocarbon comprises xylene, toluene, or both xylene and toluene.

Aspect 5. The asphaltene or paraffin wax deposit removal composition of Aspect 4, wherein the aliphatic hydrocarbon comprises a C4 to C10 saturated hydrocarbon.

Aspect 6. The asphaltene or paraffin wax deposit removal composition of any one of Aspects 1 to 5, wherein: the aromatic hydrocarbon is present in a range of from 1 wt % to 99 wt % based on a total weight of the asphaltene or paraffin wax deposit removal composition; the aliphatic hydrocarbon is present in a range of from 1 wt % to 99 wt % based on a total weight of the asphaltene or paraffin wax deposit removal composition; or both the aromatic hydrocarbon and the aliphatic hydrocarbon are present in a range of from 1 wt % to 99 wt % based on a total weight of the asphaltene or paraffin wax deposit removal composition.

Aspect 7. The asphaltene or paraffin wax deposit removal composition of any one of Aspects 1 to 6, wherein the continuous phase fluid comprises water, a glycol, an alcohol, an ether, an aromatic hydrocarbon, a ketone, an aliphatic hydrocarbon, or combinations thereof.

Aspect 8. The asphaltene or paraffin wax deposit removal composition of any one of Aspects 1 to 7, wherein the continuous phase fluid comprises an aqueous fluid, a non-aqueous fluid, and a surfactant having a hydrophilic-lipophilic balance (HLB) in a range of from 6 to 10.

Aspect 9. The asphaltene or paraffin wax deposit removal composition of Aspect 8, wherein the surfactant comprises an alkylbenzene sulfonic acid.

Aspect 10. The asphaltene or paraffin wax deposit removal composition of Aspect 8 or 9, wherein a dispersion or emulsion of the silica nanoparticles in the aqueous fluid is present in a range of from 1 wt % to 20 wt %, the non-aqueous fluid is present in a range of from 50 wt % to 94 wt %, and the surfactant is present in a range of from 5 wt % to 30 wt % based on a total weight of the silica nanoparticle component.

Aspect 11. The asphaltene or paraffin wax deposit removal composition of any one of Aspects 8 to 10, wherein the continuous phase fluid comprises water, wherein the asphaltene or paraffin wax deposit removal composition is a water-in-hydrocarbon microemulsion.

Aspect 12. The asphaltene or paraffin wax deposit removal composition of any one of Aspects 1 to 11, wherein the continuous phase fluid is non-aqueous, wherein the asphaltene or paraffin wax deposit removal composition is a dispersion of the silica nanoparticles in a mixture of the continuous phase fluid and the carrier component.

Aspect 13. A method comprising: introducing an asphaltene or paraffin wax deposit removal composition of any one of Aspects 1 to 12 into a wellbore or a production line that is fluidly coupled to the wellbore.

Aspect 14. The method of Aspect 13, further comprising: contacting the asphaltene deposit, the paraffin wax deposit, or both the asphaltene deposit and the paraffin wax deposit with the asphaltene or paraffin wax deposit removal composition in the wellbore or in the production line.

Aspect 15. The method of Aspect 14, further comprising: removing the asphaltene deposit, the paraffin wax deposit, or both the asphaltene deposit and the paraffin wax deposit based on contacting.

Aspect 16. The method of any one of Aspects 13 to 15, further comprising: producing a hydrocarbon-containing fluid from a subterranean formation via the wellbore, wherein introducing the asphaltene or paraffin wax deposit removal composition adds the asphaltene or paraffin wax deposit removal composition to the hydrocarbon-containing fluid while producing the hydrocarbon-containing fluid.

Aspect 17. The method of Aspect 16, further comprising: contacting the asphaltene deposit, the paraffin wax deposit, or both the asphaltene deposit and the paraffin wax deposit with the asphaltene or paraffin wax deposit removal composition during producing.

Aspect 18. The method of Aspect 17, further comprising: removing the asphaltene deposit, the paraffin wax deposit, or both the asphaltene deposit and the paraffin wax deposit based on contacting and during producing.

Aspect 19. A method comprising: contacting an asphaltene deposit, a paraffin wax deposit, or both an asphaltene deposit and a paraffin wax deposit with an asphaltene or paraffin wax deposit composition of any one of Aspects 1 to 12; and removing the asphaltene deposit, the paraffin wax deposit, or both the asphaltene deposit and the paraffin wax deposit based on the contacting.

Aspect 20. The method of Aspect 19, wherein contacting and removing are in a wellbore or in a production line coupled with the wellbore.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An asphaltene or paraffin wax deposit removal composition comprising:
a carrier component comprising an aromatic hydrocarbon, an aliphatic hydrocarbon, or both an aromatic hydrocarbon and an aliphatic hydrocarbon; and
a silica nanoparticle component comprising silica nanoparticles and a continuous phase fluid, wherein the silica nanoparticles are present in a range of from 0.1 wt % to 1 wt % based on a total weight of the asphaltene or paraffin wax deposit removal composition.

2. The asphaltene or paraffin wax deposit removal composition of claim 1, wherein the silica nanoparticles have an average particle size of from 1 nm to 1,000 nm.

3. The asphaltene or paraffin wax deposit removal composition of claim 1, wherein the silica nanoparticles are present in a range of from 30 wt % to 40 wt % and the continuous phase fluid is present in a range of from 60 wt % to 70 wt % based on a total weight of the silica nanoparticle component.

4. The asphaltene or paraffin wax deposit removal composition of claim 1, wherein the aromatic hydrocarbon comprises xylene, toluene, or both xylene and toluene.

5. The asphaltene or paraffin wax deposit removal composition of claim 4, wherein the aliphatic hydrocarbon comprises a C₄ to C₁₀ saturated hydrocarbon.

6. The asphaltene or paraffin wax deposit removal composition of claim 1, wherein:
the aromatic hydrocarbon is present in a range of from 1 wt % to 99 wt % based on a total weight of the asphaltene or paraffin wax deposit removal composition;
the aliphatic hydrocarbon is present in a range of from 1 wt % to 99 wt % based on a total weight of the asphaltene or paraffin wax deposit removal composition; or
both the aromatic hydrocarbon and the aliphatic hydrocarbon are present in a range of from 1 wt % to 99 wt % based on a total weight of the asphaltene or paraffin wax deposit removal composition.

7. The asphaltene or paraffin wax deposit removal composition of claim 1, wherein the continuous phase fluid comprises water, a glycol, an alcohol, an ether, an aromatic hydrocarbon, a ketone, an aliphatic hydrocarbon, or combinations thereof.

8. The asphaltene or paraffin wax deposit removal composition of claim 7, wherein the continuous phase fluid comprises an aqueous fluid, a non-aqueous fluid, and a surfactant having a hydrophilic-lipophilic balance (HLB) in a range of from 6 to 10.

9. The asphaltene or paraffin wax deposit removal composition of claim 8, wherein the surfactant comprises an alkylbenzene sulfonic acid.

10. The asphaltene or paraffin wax deposit removal composition of claim 8, wherein a dispersion or emulsion of the silica nanoparticles in the aqueous fluid is present in a range of from 1 wt % to 20 wt %, the non-aqueous fluid is present in a range of from 50 wt % to 94 wt %, and the surfactant is present in a range of from 5 wt % to 30 wt % based on a total weight of the silica nanoparticle component.

11. The asphaltene or paraffin wax deposit removal composition of claim 8, wherein the continuous phase fluid comprises water, wherein the asphaltene or paraffin wax deposit removal composition is a water-in-hydrocarbon microemulsion.

12. The asphaltene or paraffin wax deposit removal composition of claim 1, wherein the continuous phase fluid is non-aqueous, wherein the asphaltene or paraffin wax deposit removal composition is a dispersion of the silica nanoparticles in a mixture of the continuous phase fluid and the carrier component.

13. A method comprising:
introducing an asphaltene or paraffin wax deposit removal composition of claim 1 into a wellbore or a production line that is fluidly coupled to the wellbore.

14. The method of claim 13, further comprising:
contacting the asphaltene deposit, the paraffin wax deposit, or both the asphaltene deposit and the paraffin wax deposit with the asphaltene or paraffin wax deposit removal composition in the wellbore or in the production line.

15. The method of claim 14, further comprising:
removing the asphaltene deposit, the paraffin wax deposit, or both the asphaltene deposit and the paraffin wax deposit based on contacting.

16. The method of claim 13, further comprising:
producing a hydrocarbon-containing fluid from a subterranean formation via the wellbore, wherein introducing the asphaltene or paraffin wax deposit removal composition adds the asphaltene or paraffin wax deposit removal composition to the hydrocarbon-containing fluid while producing the hydrocarbon-containing fluid.

17. The method of claim 16, further comprising:
contacting the asphaltene deposit, the paraffin wax deposit, or both the asphaltene deposit and the paraffin wax deposit with the asphaltene or paraffin wax deposit removal composition during producing.

18. The method of claim 17, further comprising:
removing the asphaltene deposit, the paraffin wax deposit, or both the asphaltene deposit and the paraffin wax deposit based on contacting and during producing.

19. A method comprising:
contacting an asphaltene deposit, a paraffin wax deposit, or both an asphaltene deposit and a paraffin wax deposit with an asphaltene or paraffin wax deposit composition of claim 1; and
removing the asphaltene deposit, the paraffin wax deposit, or both the asphaltene deposit and the paraffin wax deposit based on the contacting.

20. The method of claim 19, wherein contacting and removing are in a wellbore or in a production line coupled with the wellbore.
